(19) United States
(12) Patent Application Publication
(10) Pub. No.: US 2025/0083238 A1
(43) Pub. Date: Mar. 13, 2025

(54) AUXILIARY BASE AND JIGSAW

(71) Applicant: MAKITA CORPORATION, Anjo-shi (JP)

(72) Inventor: Syuji AOYAMA, Anjo-shi (JP)

(73) Assignee: MAKITA CORPORATION, Anjo-shi (JP)

(21) Appl. No.: 18/668,766

(22) Filed: May 20, 2024

(30) Foreign Application Priority Data
Sep. 11, 2023 (JP) 2023-147142

(51) Int. Cl. B23D 51/02

(52) U.S. Cl. CPC B23D 51/02

(57) ABSTRACT

An auxiliary base further improves the stability of a jigsaw during cutting as appropriate. An auxiliary base is attachable to a jigsaw. The jigsaw includes a base unit to be in contact with a workpiece, and a body tiltable relative to the base unit in a lateral direction. The auxiliary base includes a contact portion to be in contact with the workpiece when the auxiliary base is attached to the jigsaw. The auxiliary base is attachable with an auxiliary width from the contact portion to a middle of the base unit in the lateral direction of the body being greater than a width of the base unit in the lateral direction.

### CROSS-REFERENCE TO RELATED APPLICATIONS

This application claims the benefit of priority to Japanese Patent Application No.

2023-147142, filed on Sep. 11, 2023, the entire contents of which are hereby incorporated by reference.

### BACKGROUND

### 1. Technical Field

The disclosure relates to a jigsaw for cutting workpieces with a blade, and to an auxiliary base.

### 2. Description of the Background

A known jigsaw is described in Japanese Unexamined Patent Application Publication No. 2013-144334 (Patent Literature 1).

The jigsaw includes a body and a base connected to a lower portion of the body. The base includes a branched portion at its front. The base includes auxiliary bases at the center of the branched portion. Each auxiliary base is extendable and retractable in a plane parallel to the lower surface of the base between a retracted position at which the auxiliary base fits within the base and an extended position at which the auxiliary base extends from its holder and protrudes outward from the base.

### BRIEF SUMMARY

A known auxiliary base is retractable in a holder in a base, thus having a limitation in its size. A known jigsaw thus has a limitation in improving stability during cutting.

A first aspect of the disclosure provides an auxiliary base attachable to a jigsaw, the jigsaw including a base unit to be in contact with a workpiece, and a body tiltable relative to the base unit in a lateral direction, the auxiliary base including:
a contact portion configured to be in contact with the workpiece when the auxiliary base is attached to the jigsaw,
wherein the auxiliary base is attachable with an auxiliary width from the contact portion to a middle of the base unit in the lateral direction of the body being greater than a width of the base unit in the lateral direction.

A second aspect of the disclosure provides an auxiliary base attachable to a jigsaw, the jigsaw including a base unit to be in contact with a workpiece, and a body tiltable relative to the base unit in a lateral direction, the auxiliary base including:
a contact portion configured to be in contact with the workpiece when the auxiliary base is attached to the jigsaw, the contact portion being at a position farther in a direction in which the body is tilted than a center of gravity of the jigsaw having the body tilted at an angle of 45° in the lateral direction of the body.

A third aspect of the disclosure provides a jigsaw, including:
the auxiliary base according to any one of the above aspects.

The auxiliary base according to the above aspects of the disclosure can further improve the stability of the jigsaw during cutting as appropriate.

The jigsaw according to the above aspects of the disclosure has further improved stability during cutting as appropriate.

### BRIEF DESCRIPTION OF DRAWINGS

FIG. 1 is a perspective view of a jigsaw according to a first embodiment with a body and a handle tilted rightward, showing its front surface, upper surface, and left surface.

FIG. 2 is a front view of the jigsaw according to the first embodiment.

FIG. 3 is a front view of the jigsaw according to the first embodiment with the body and the handle standing upright.

FIG. 4 is an enlarged view of an auxiliary base in the jigsaw according to the first embodiment and components around the auxiliary base.

FIG. 5 is a central sectional view of the auxiliary base in the jigsaw according to the first embodiment.

FIG. 6 is a perspective view of the jigsaw according to the first embodiment, showing its front surface, lower surface, and left surface.

FIG. 7 is an exploded perspective view of a base unit and the auxiliary base in the jigsaw according to the first embodiment, showing their front surfaces, lower surfaces, and left surfaces.

FIG. 8 is a central sectional view of the auxiliary base with a cover plate attached.

FIG. 9 is an enlarged view of the auxiliary base and the components around the auxiliary base when the body and the handle are tilted leftward.

FIG. 10A is a perspective view of an auxiliary base in a jigsaw according to a second embodiment.

FIG. 10B is a perspective view of the auxiliary base in the second embodiment as viewed in the direction opposite to FIG. 10A.

### DETAILED DESCRIPTION

Embodiments of the disclosure will now be described with reference to the drawings as appropriate. In the embodiments describe below, modifications are also described. The disclosure is not limited to the embodiments and the modifications.

The directional terms such as front, rear, up, down, right, and left in the embodiments and the modifications are defined for ease of explanation, and may be changed based on, for example, at least the operating situations or the movement of a component.

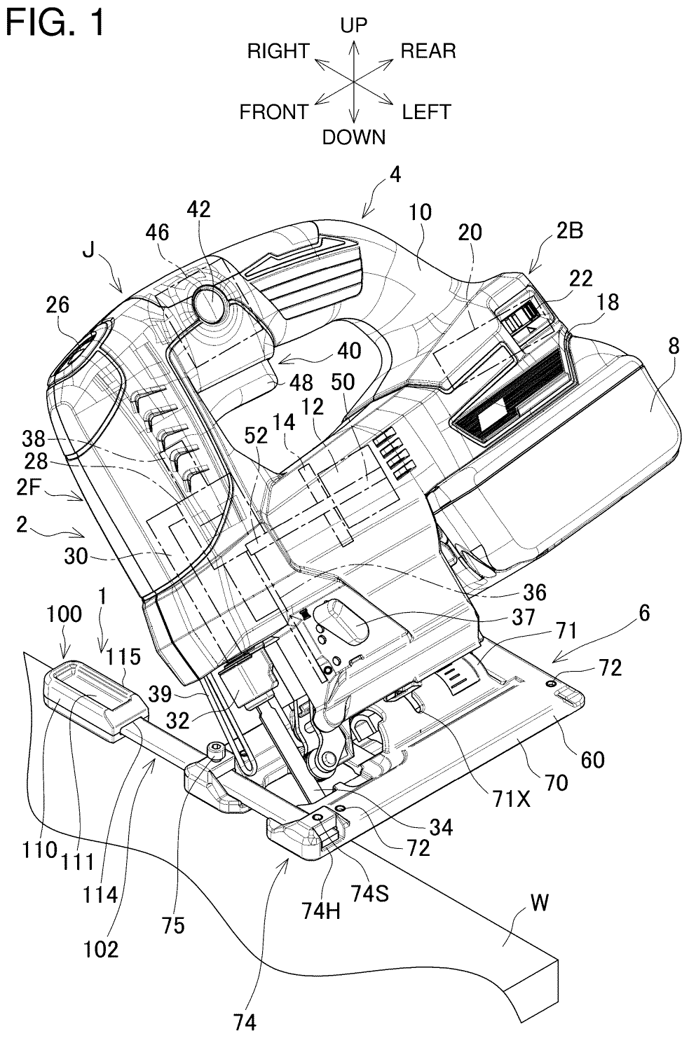

FIG. 1 is a perspective view of a jigsaw J according to a first embodiment with a

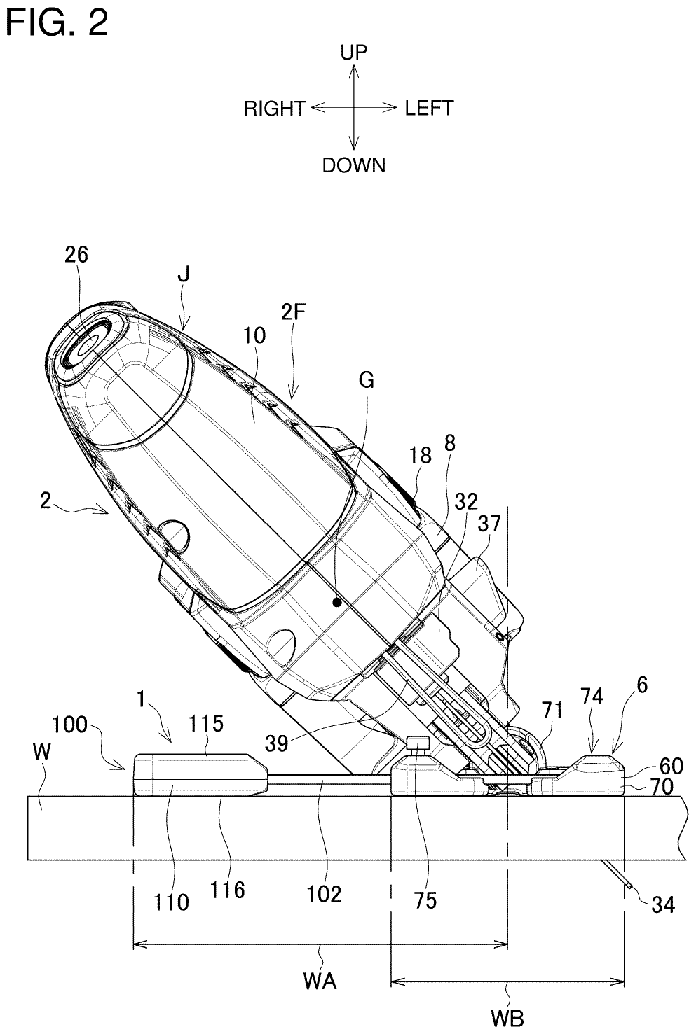

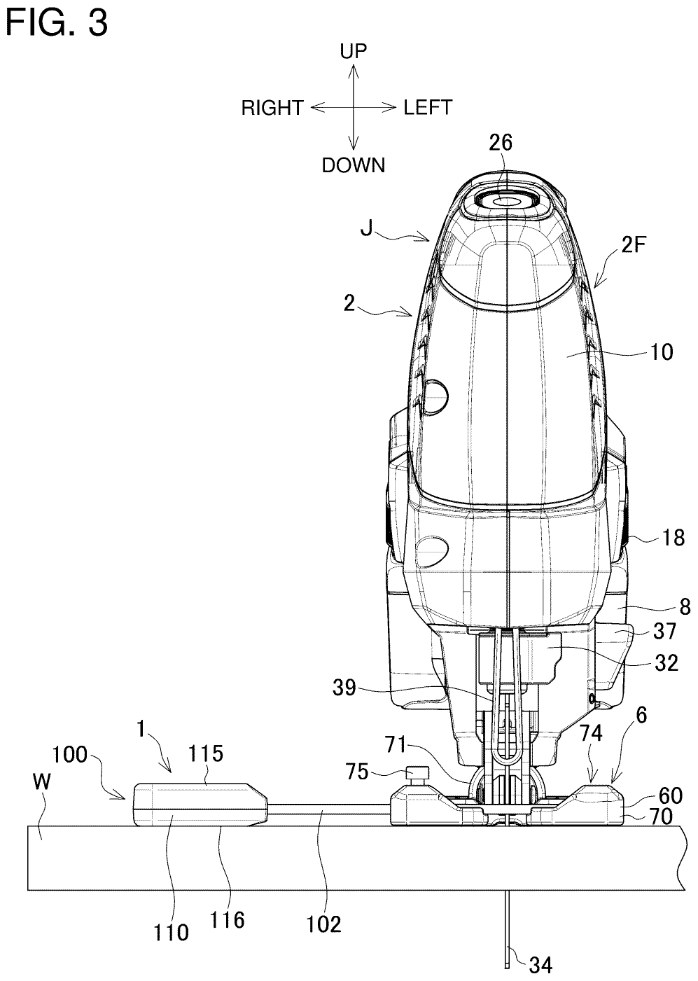

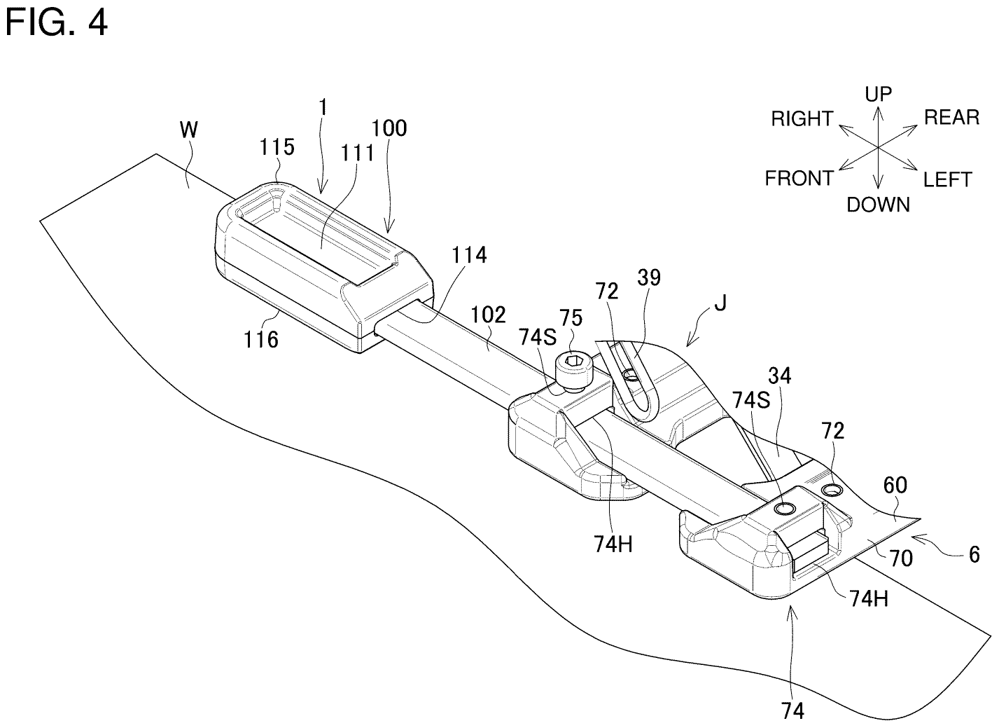

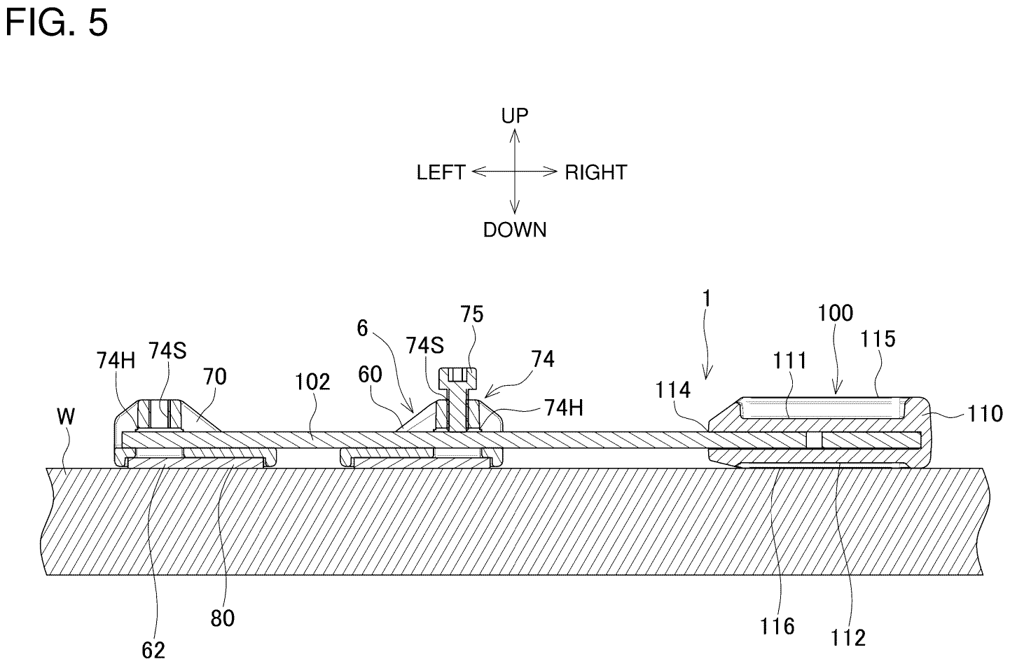

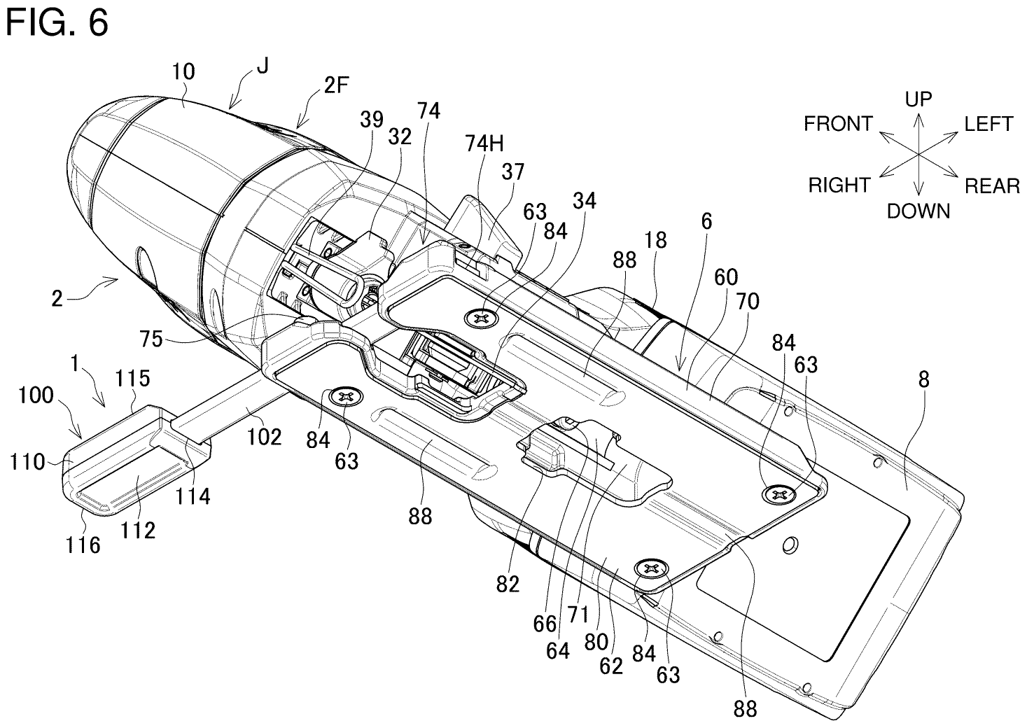

body 2 and a handle 4 tilted rightward, showing its front surface, upper surface, and left surface. FIG. 2 is a front view of the jigsaw J. FIG. 3 is a front view of the jigsaw J with the body 2 and the handle 4 standing upright. FIG. 4 is an enlarged view of an auxiliary base 1 and components around the auxiliary base 1. FIG. 5 is a central sectional view of the auxiliary base 1. FIG. 6 is a perspective view of the jigsaw J showing its front surface, lower surface, and left surface.

The jigsaw J includes the auxiliary base 1, the body 2, the handle 4, a base unit 6, and a rechargeable battery 8. The jigsaw J is rechargeable and driven with the battery 8. The battery 8 is a battery for power tools. At least one of the handle 4 or the battery 8 may be a component of the body 2. At least one of the auxiliary base 1 or the battery 8 may be independent of the jigsaw J. The battery 8 may be a primary battery. The battery 8 may be any battery, such as a general-purpose battery, other than the battery for power tools. The battery 8 may be replaced with a power cable connectable to a power supply. A jigsaw including a power cord connectable to an alternating current (AC) power supply is an AC-powered jigsaw.

In FIGS. 1, 2, 4, and 6, the body 2 and the handle 4 are tilted rightward by 45° relative to the base unit 6 in the vertical direction. The jigsaw J can adjust the orientations of the body 2 and the handle 4 relative to the base unit 6. In FIG. 3, the body 2 and handle 4 are in their vertical positions, or in other words, standing upright.

In FIG. 2, up, down, left, and right are basically defined as viewed from the user of the jigsaw J.

For ease of explanation, however, the direction from the upper left to the lower right in FIG. 2 corresponds to the vertical direction of the body 2 and the handle 4. In FIG. 2, the vertical direction from the upper right to the lower left is the lateral direction of the body 2 and the handle 4. For ease of explanation, the body 2 and the handle 4 will be described below with reference to the directions shown in FIG. 3 in which the body 2 and the handle 4 stand upright relative to the horizontal base unit 6, rather than with reference to the directions shown in FIGS. 1, 2, 4, and 6.

The body 2 is substantially L-shaped as viewed from the left to the right. The body 2 includes a body front portion 2F at the front. The body front portion 2F extends vertically. The body 2 includes a body rear portion 2B at the rear. The body rear portion 2B extends rearward from the lower rear of the body front portion 2F.

The body 2 includes a housing 10, an electric motor 12, a fan 14, a battery mount 18, a controller 20, a speed adjustment switch 22, a main power switch 26, a power transmitter 28, a slider (output unit) 30, a tip tool mount 32, a blade (tip tool) 34, an orbital unit 36, an orbital switcher 37, a counterweight unit 38, and a guard 39.

The body 2 includes, in order from the rear, the battery mount 18, the controller 20, the electric motor 12, the fan 14, the power transmitter 28, the orbital unit 36, the counterweight unit 38, the slider 30, the tip tool mount 32, and the guard 39.

The arrangement of the components and portions may be modified variously. The blade 34 may be independent of the body 2 or the jigsaw J rather than as a component of the body 2 or the jigsaw J. The slider 30 may be a component of the power transmitter 28, and the tip tool mount 32 may serve as the output unit. The slider 30 and the tip tool mount 32 may serve as the output unit.

The housing 10 defines outer walls of the body 2 and the handle 4. The housing 10 holds various components directly or indirectly. The housing 10 is halved into right and left portions.

The housing 10 may be modified variously. For example, the outer wall of the body 2 and the outer wall of the handle 4 in the housing 10 may be separate and may be joined together. In the halved housing 10, the left portion and the right portion may largely differ from each other in at least one of the size or the shape. At least the materials of the components of the housing 10 or the number and arrangement of openings in the housing 10 may be modified.

The handle 4 includes a main switch unit 40 and a lock-on switch 42. At least one of the main switch unit 40 or the lock-on switch 42 may be located in the body 2.

The main switch unit 40 includes a main switch 46 and a trigger 48. The main switch 46 is electrically connected to the controller 20. The trigger 48 is fixed to a plunger in the main switch 46. The trigger 48 includes a lower portion exposed downward through an opening in the handle 4 in the housing 10. The trigger 48 is vertically slidable and operable upward by the user.

The main switch 46 is turned off when the trigger 48 is at a lowermost position. In response to the trigger 48 being slid upward from the lowermost position, the main switch 46 is turned on after a predetermined play. Upon being operated upward further from the on-state, the main switch 46 changes the state of an output signal in response to the amount of upward operation to change the rotational speed of the electric motor 12.

The main switch 46 may not change the state of an output signal in response to the amount of upward operation. In some embodiments, the play may be eliminated, and the main switch 46 may be turned on immediately after the start of upward operation of the trigger 48.

The lock-on switch 42 is a button switch that switches in response to a push operation by the user. The lock-on switch 42 is electrically connected to the controller 20.

At least one of the main switch 46 or the lock-on switch 42 may be of any type. For example, the lock-on switch 42 may be a toggle switch rather than the button switch. Other switches may also be of any type.

The electric motor 12 is a direct current (DC) brushless motor. The electric motor 12 is held in the housing 10. The housing 10 can serve as a motor housing to hold the electric motor 12.

The electric motor 12 includes a motor shaft 50 extending in the front-rear direction. The motor shaft 50 rotates on its imaginary central axis.

The motor shaft 50 has a pinion 52 located at its front end.

The fan 14 is integrally fixed to the motor shaft 50. The fan 14 is a centrifugal fan. Another fan such as an axial flow fan may be used as the fan 14.

The housing 10 has a lower opening with the rear of the opening located radially outward from the fan 14.

The battery mount 18 is located at the lower rear end of the body 2. The battery 8 is attachable to the battery mount 18. The battery mount 18 includes a body terminal connectable to a terminal on the battery 8. The body terminal is received in a lower rear opening of the housing 10.

The battery 8 is slid forward from the rear of the battery mount 18 and attached to a lower portion of the battery mount 18. The sliding direction of the battery 8 for attachment may be in a direction other than the direction from the rear to the front. The battery 8 may be attached in a manner other than sliding.

The battery 8 is a lithium-ion battery of 18 V (volt). The battery 8 contains eight cells (not shown) in a plastic battery case. The cells are axially elongated columns and extend laterally when the battery 8 is attached. The battery 8 retains power for driving the electric motor 12.

The battery 8 may be any lithium-ion battery with a voltage of 10.8, 14.4, 25.2, 28, or 36 V. The battery 8 may be a lithium-ion battery with a voltage of less than 10.8 V or more than 36 V. The battery 8 may be another type of battery. Multiple batteries 8 may be used.

The controller 20 is held inside the battery mount 18. The controller 20 controls the electric motor 12. The controller 20 is electrically connected to the electric motor 12. The controller 20 is electrically connected to the body terminal on the battery mount 18.

The controller 20 is electrically connected to the speed adjustment switch 22 and the main power switch 26.

The speed adjustment switch 22 is a dial switch. The speed adjustment switch 22 includes a disk extending in the front-rear and lateral directions. The disk in the speed adjustment switch 22 is rotatable about an imaginary central axis extending vertically. A left portion of the disk in the speed adjustment switch 22 is exposed through a hole in the left surface of the housing 10. The user rotates the left portion of the disk by directing the left portion forward or rearward. The speed adjustment switch 22 outputs a signal corresponding to the amount of rotation of the disk. The output signal is transmitted to the controller 20.

The speed adjustment switch 22 may be eliminated.

The main power switch 26 is a tactile switch. The main power switch 26 is held in an upper front portion of the housing 10.

The main power switch 26 alternately transmits an on-signal and an off-signal to the controller 20 upon every push on the controller 20 by the user.

The power transmitter 28 transmits power from the electric motor 12 to the blade 34 through the slider 30 and the tip tool mount 32. The slider 30 is cylindrical. The slider 30 extends vertically. The tip tool mount 32 is held at the lower end of the slider 30. The slider 30 can reciprocate in the vertical direction. The tip tool mount 32 can reciprocate in the vertical direction.

The slider 30 extends vertically and is movable vertically. The slider 30 has its lower portion swingable back and forth relative to its upper end.

The tip tool mount 32 is held by the slider 30. The tip tool mount 32 is connected to the lower end of the slider 30.

The blade 34 extends vertically. The blade 34 includes a workpiece acting part on one long edge. The workpiece acting part acts on a workpiece W. The workpiece acting part is, for example, a saw blade that cuts the workpiece W. The upper end of the blade 34 is attached to the tip tool mount 32 with the workpiece acting part facing frontward. The blade 34 is attachable to the tip tool mount 32 in a tool-less manner, or without using any tool such as a wrench.

The orbital unit 36 is in contact with the rear edge of the blade 34. The orbital unit 36 is swingable. During the swing, the orbital unit 36 applies a force to the blade 34 in the front-rear direction. The blade 34 moving vertically receives the swinging action in the front-rear direction. This causes the blade 34 to move orbitally along an imaginary ellipse as viewed laterally.

The orbital switcher 37 includes a shaft (not shown) and a knob (shown). The shaft extends laterally. The shaft is located inside the housing 10.

The knob is fixed to the left end of the shaft. The knob is located on the left of the left surface of the housing 10. The knob extends radially outward from the shaft.

The user can operate the knob to rotate the orbital switcher 37 about an imaginary central axis of the shaft. The rotation of the shaft of the orbital switcher 37 switches the on-off state and the degree of swinging of the orbital unit 36.

The counterweight unit 38 includes a counterweight (not shown). The counterweight in the counterweight unit 38 moves vertically in a manner opposite to the slider 30, the tip tool mount 32, and the blade 34. This structure reduces vibrations resulting from the reciprocation of the slider 30, the tip tool mount 32, and the blade 34.

The guard 39 extends vertically. The guard 39 has its upper end held by the housing 10. The guard 39 has its lower end adjacent to the upper surface of the base unit 6.

The blade 34 is located behind the guard 39.

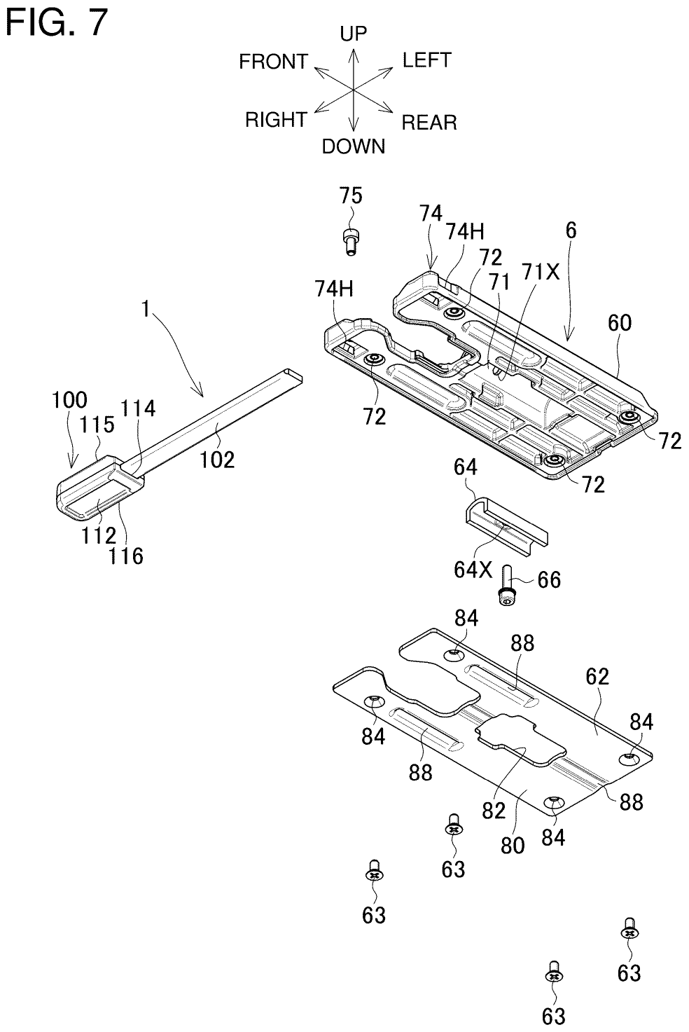

FIG. 7 is an exploded perspective view of the base unit 6 and the auxiliary base 1, showing their front surfaces, lower surfaces, and left surfaces. The base unit 6 is attached to a lower portion of the body 2.

The base unit 6 includes a base 60, a base plate 62, multiple (four) screws 63, a clamp plate 64, a bolt 66, and a cover plate C.

The base 60 is formed from an aluminum die-cast alloy. The base 60 is a plate extending in the front-rear and lateral directions.

The base 60 includes a base body 70, a raised portion 71, multiple (four) threaded holes 72, ruler mounts 74, and a tap bolt 75.

The base body 70 is a plate. The base body 70 includes a branched portion at the front. The blade 34 can pass through a space defined by the branched portion of the base body 70.

The raised portion 71 is located at the center of the base body 70. The raised portion 71 is raised upward from the base body 70. The raised portion 71 has a cross hole 71X at the center. The cross hole 71X is cross-shaped and elongated in the front-rear and lateral directions. The portion of the cross hole 71X elongated in the lateral direction is arc-shaped as viewed from the front to the rear.

The threaded holes 72 are adjacent to the four corners of the base body 70. Each threaded hole 72 extends vertically.

The ruler mounts 74 are located at the front ends of the branched portion of the base body 70. The ruler mounts 74 have multiple (a pair of) holes 74H and multiple (a pair of) threaded holes 74S. Each hole 74H extends laterally. Each hole 74H can receive a single ruler (not shown). Each threaded hole 74S extends vertically. Each threaded hole 74S can receive the tap bolt 75 placed downward from above to press the ruler. The ruler is attachable to the ruler mounts 74. The ruler is, for example, a parallel ruler that guides the jigsaw J parallel to the surface of the workpiece W for cutting.

The tap bolt 75 may be a component of a member in the base unit 6 other than the base body 70, a component of the auxiliary base 1, or a component independent of the jigsaw J. Multiple tap bolts 75 may be used.

The base plate 62 is a metal plate such as a steel plate. The base plate 62 is placed on the lower surface of the base unit 6 to reduce wear of the base unit 6 caused by contact with the workpiece W.

The base plate 62 includes a base plate body 80, a hole 82, multiple (four) threaded holes 84, and multiple (three) ribs 88.

The base plate body 80 is a plate. The base plate body 80 has a branched portion at the front. The blade 34 can pass through a space defined by the branched portion of the base plate body 80. The base plate body 80 has the same shape and size as the base body 70 as viewed from below.

The hole 82 is at the center of the base plate body 80. The hole 82 is located below the cross hole 71X in the base 60.

The threaded holes 84 are adjacent to the four corners of the base plate body 80. Each threaded hole 84 extends vertically. The threaded holes 84 are aligned with the respective threaded holes 72 in the base 60 as viewed from below.

Each rib 88 is an upward bend of the base plate body 80.

One of the ribs 88 extends across the hole 82 in the front-rear direction. The rib 88 and its adjacent portions together have an Ω-shaped cross section as viewed from the rear.

The other two ribs 88 extend in the front-rear direction. The two ribs 88 are located at the basal ends of the branched portion of the base plate body 80.

The ribs 88 increase the rigidity of the base plate 62. At least one of the ribs 88 may be eliminated.

Each screw 63 is received in the corresponding threaded hole 72 and threaded hole 84. Each screw 63 fastens the base 60 and the base plate 62 together.

The clamp plate 64 is a plate. The clamp plate 64 has an arch-shaped cross section. The clamp plate 64 has a bolt hole 64X at the center. The clamp plate 64 may be eliminated.

The bolt 66 extends vertically with the head facing downward. The bolt 66 is placed through the bolt hole 64X and the cross hole 71X and is received in a nut (not shown) held on the housing 10.

The base unit 6 is fastened to the body 2 with the bolt 66 received in the nut and the clamp plate 64.

The user changes, as appropriate, at least the orientations of the body 2 and the handle 4 relative to the base unit 6 (the tilt angle of the body 2 and the handle 4 to the left or right) or the positions of the body 2 and the handle 4 relative to the base unit 6 in the front-rear direction.

More specifically, the user places a wrench (not shown) through the hole 82 into the head of the bolt 66 and unfastens the bolt 66. The base unit 6 is then unfastened from the body 2, allowing the bolt 66 to move along the cross hole 71X. The user moves the bolt 66 along the portion of the cross hole 71X elongated in the lateral direction to change the orientations of the body 2 and the handle 4 relative to the base unit 6. In other words, the tilt angles of the body 2 and the handle 4 are changeable relative to the base unit 6. The body 2 and the handle 4 are tiltable relative to the base unit 6. The user tightens the bolt 66 at an intended orientation to complete the operation of changing the orientation.

In FIGS. 1, 2, 4, and 6, the body 2 and the handle 4 are tilted rightward by 45° relative to the base unit 6. The tilt angle is an angle relative to an imaginary plane extending in the front-rear and vertical directions and perpendicular to the base unit 6, or specifically, to a portion of the plane including a middle portion of the body 2 in the lateral direction. The body 2 and the handle 4 are tiltable in the lateral direction.

To change the positions of the body 2 and the handle 4 relative to the base unit 6 in the front-rear direction, the user unfastens the bolt 66 with a wrench and moves the bolt 66 along a portion of the cross hole 71X elongated in the front-rear direction. The bolt 66 is then tightened at an intended position.

When the bolt 66 is at the intersection between the portion of the cross hole 71X elongated in the front-rear direction and the portion of the cross hole 71X elongated in the lateral direction, the body 2 and the handle 4 are basically at a reference position relative to the base unit 6. When the body 2 and handle 4 are tilted rightward by 45° as shown in FIGS. 1, 2, 4, and 6, the jigsaw J with the battery 8 attached has the center of gravity G in FIG. 2.

The auxiliary base 1 extends laterally. The auxiliary base 1 includes a head 100 and a leg 102. The head 100 is formed from plastic.

The head 100 includes a head body 110, a first recesses 111, a second recess 112, a slit 114, a first protrusion 115, and a second protrusion 116.

The head body 110 is a block.

The first recess 111 is located on the upper surface of the head body 110. The first recess 111 is recessed downward from the upper surface of the head body 110. The first recess 111 defines the first protrusion 115 on an upper portion of the head body 110. The first protrusion 115 protrudes upward from the bottom surface of the first recess 111. The first protrusion 115 is rectangular and surrounds a center portion of the upper surface of the head body 110. Either the first recess 111 or the first protrusion 115 alone may be defined to relatively define the other of the first recess 111 or the first protrusion 115.

The second recess 112 is located on the lower surface of the head body 110. The

second recess 112 is recessed upward from the lower surface of the head body 110. The second recess 112 defines the second protrusion 116 on a lower portion of the head body 110. The second protrusion 116 protrudes downward from the bottom surface of the second recess 112. The second protrusion 116 is rectangular and surrounds a center portion of the lower surface of the head body 110. The second recess 112 is shallower than the first recess 111 in the vertical direction. The second protrusion 116 has a smaller height than the first protrusion 115 in the vertical direction.

Either the second recess 112 or the second protrusion 116 alone may be defined to relatively define the other of the second recess 112 or the second protrusion 116. The second recess 112 may have a depth greater than or equal to the depth of the first recess 111. The second protrusion 116 may have a height greater than or equal to the height of the first protrusion 115. At least one of the first protrusion 115 or the second protrusion 116 may not be rectangular.

The slit 114 extends rightward from a center portion of the left surface of the head body 110. The slit 114 has the same size as the right end of the leg 102.

At least one of the first recess 111, the second recess 112, the first protrusion 115, or the second protrusion 116 may be eliminated.

The leg 102 is a metal plate. The leg 102 extends laterally.

The leg 102 has its right end received in the slit 114. The leg 102 is fixed to the head 100. The head 100 and the leg 102 are connected to each other. The leg 102 protrudes leftward from the left surface of the head 100.

The leg 102 has its right end with the same shape as the holes 74H in the ruler mounts 74. The distance from the lower surface of the leg 102 to the lower surface of the head body 110 in the vertical direction corresponds to the distance from the lower surface of each hole 74H to the lower surface of the base unit 6 in the vertical direction.

The auxiliary base 1 is attached to the base unit 6 with the leg 102 fastened to the ruler mounts 74. The auxiliary base 1 is located frontward from the blade 34. The front-rear direction is perpendicular to the lateral and vertical directions. The leg 102 is a component to be attached to a mount portion of the base unit 6.

In FIGS. 1, 2, 4, and 6, the left end of the leg 102 is placed through the holes 74H from the right to the left. The tap bolt 75 is placed in the right threaded hole 74S. The tap bolt 75 presses a middle portion of the leg 102 downward.

As the leg 102 is placed through the holes 74H more leftward, the head 100 is located more leftward. As the leg 102 is placed through the hole 74H less leftward, the head 100 is located relatively rightward. The position of the auxiliary base 1 is adjustable relative to the base unit 6 in the lateral direction. The user can fasten the auxiliary base 1 to the base unit 6 by tightening the tap bolt 75 at an intended position.

The lower surface of the head 100 in the auxiliary base 1 attached to the base unit 6, or the lower end of the second protrusion 116, comes in contact with the upper surface of the workpiece W together with the lower surface of the base unit 6. The lower surface of the head 100 and the lower surface of the base unit 6 are included in the same imaginary plane.

The head 100 has its right end located rightward from the center of gravity G of the overall jigsaw J in the lateral direction of the body 2. When the body 2 is tilted rightward, the right end of the head 100 is at a position farther in a direction in which the body 2 is tilted than the center of gravity G. The direction in which the body 2 is tilted is the direction in which the body 2 is tiltable. The head 100 in the auxiliary base 1 supports the body 2 and the handle 4 tilted rightward at the position farther in the direction in which the body 2 is tilted than the center of gravity G. The body 2 and the handle 4 are thus supported sufficiently stably.

As shown in FIG. 2, an auxiliary width WA that is a distance from the right end of the auxiliary base 1 to the middle of the base in the lateral direction is greater than or equal to a width WB of the base unit 6 that is the dimension of the base unit 6 in the lateral direction. The dimension of the base unit 6 in the lateral direction refers to the dimension of the base unit 6 in the direction in which the body 2 and the handle 4 are tiltable. The auxiliary base 1 has its right end corresponding to the right side of the second protrusion 116. The second protrusion 116 is a portion of the auxiliary base 1 that can come in contact with the workpiece W. The body 2 and the handle 4 are thus supported sufficiently stably.

The stability described above can be achieved with a tilt angle other than 45° rightward.

In the structure in FIGS. 1, 2, 4, and 6, a first distance that is a vertical distance from the leg 102 to the lower end of the second protrusion 116 corresponds to the distance from each hole 74H to the lower surface of the base plate 62.

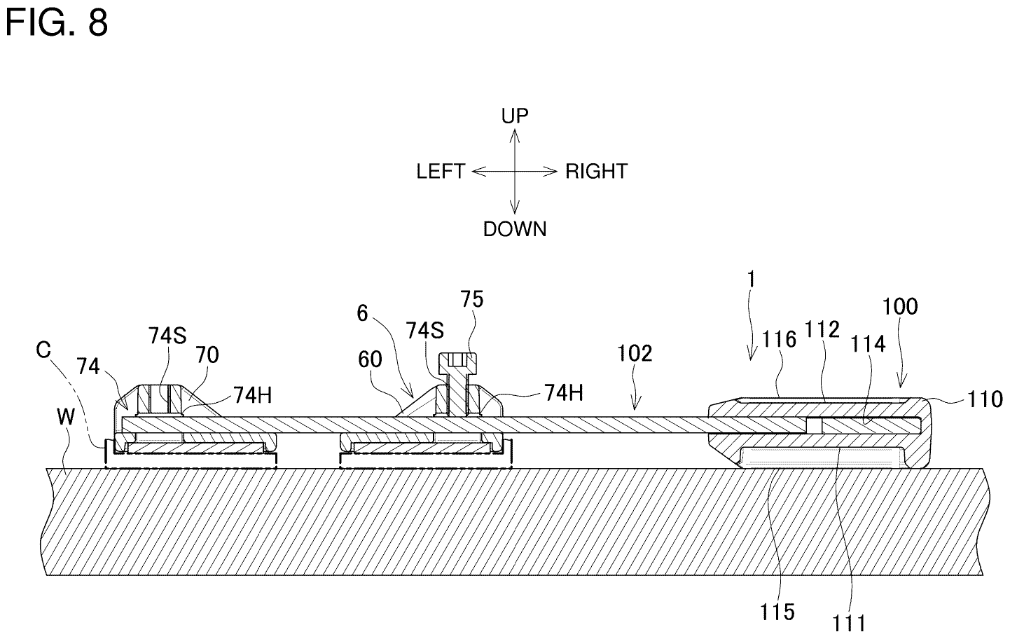

FIG. 8 is a central sectional view of the auxiliary base 1 with the cover plate C attached. In FIG. 8, the cover plate C is partially indicated by the two-dot-dash lines.

The cover plate C is formed from plastic, and is attachable to the base 60. The cover plate C covers the base 60 and a lower portion of the base plate 62. The cover plate C reduces scratches on the workpiece W resulting from sliding of the base plate 62 formed from metal. The cover plate C has its lower surface that comes in contact with the workpiece W. The cover plate C is more flexible than the base plate 62. The cover plate C thus reduces scratches on the workpiece W, such as a piece of wood, that is likely to be scratched with the base plate 62.

The cover plate C may be a component independent of the base unit 6 or the jigsaw J.

When the cover plate C is attached, the height of each hole 74H in the ruler mount 74, or more specifically, the distance from the lower surface of each hole 74H to the lower surface of the base unit 6 increases by the thickness of the cover plate C.

When the cover plate C is attached, the auxiliary base 1 is reversed in the vertical direction from when the cover plate C is unattached and is placed through the holes 74H. The auxiliary base 1 is then fastened with the tap bolt 75. In FIG. 8, a second distance that is a vertical distance from the leg 102 to the lower end of the first protrusion 115 corresponds to the distance from each hole 74H to the lower surface of the cover plate C. The lower end of the first protrusion 115 comes in contact with the upper surface of the workpiece W as a contact portion. The second distance differs from the first distance.

When the cover plate C is attached, the user attaches the auxiliary base 1 reversed in the vertical direction from when the cover plate C is unattached. This stabilizes the jigsaw J. In this case as well, the user can adjust the auxiliary base 1 relative to the base unit 6 in the lateral direction.

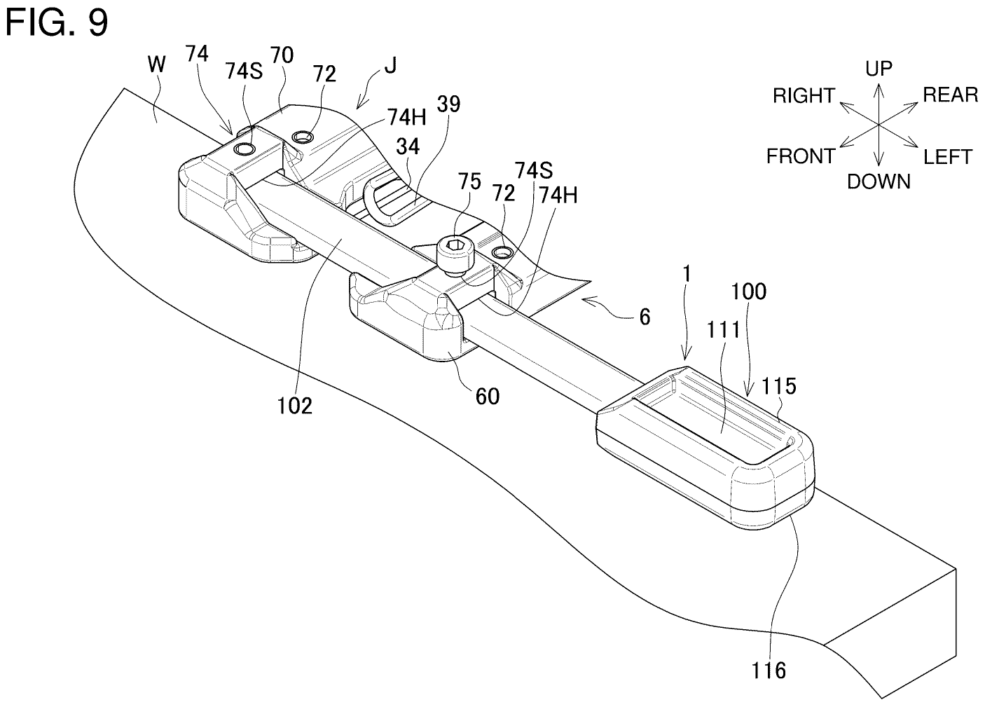

FIG. 9 is an enlarged view of the auxiliary base and the components around the auxiliary base when the body 2 and the handle 4 are tilted leftward. In FIG. 9, the cover plate C is not attached.

When the body 2 and the handle 4 are tilted leftward, the leg 102 in the auxiliary base 1 is placed through the holes 74H from the left to the right. The tap bolt 75 is placed in the left threaded hole 74S.

The head 100 is then located leftward from the base unit 6. Thus, when the body 2 and the handle 4 are tilted leftward as well, the auxiliary base 1 improves the stability of the jigsaw J. In this case as well, the user can adjust the auxiliary base 1 relative to the base unit 6 in the lateral direction.

The auxiliary base 1 is selectively attachable to the left or the right of the base unit 6. More specifically, the auxiliary base 1 is selectively attachable to either end of the base unit 6 in the lateral direction.

The auxiliary base 1 supports, with the first protrusion 115 or the second protrusion 116 serving as a contact portion, the right end of the base unit 6 when the body 2 is tilted rightward, and supports the left end of the base unit 6 when the body 2 is tilted leftward. More specifically, the first protrusions 115 or the second protrusions 116 can selectively support either end of the base unit 6 in the lateral direction.

An operation example of the jigsaw J will now be described.

The user tilts the body 2 and the handle 4 as appropriate and adjusts the tilt angles of the body 2 and the handle 4 as intended. The user attaches the blade 34 to the tip tool mount 32. The blade 34 is attachable to the tip tool mount 32 by simply placing the upper end of the blade 34 into the tip tool mount 32 and pushing in the blade 34 slightly to complete the attachment.

The user attaches the charged battery 8 to the battery mount 18. The user may change the orbital mode of the blade 34 as intended by operating the orbital switcher 37. The user operates the main power switch 26 to turn on the main power supply for the jigsaw J.

The user grips the handle 4 and operates the trigger 48 to turn on the main switch 46. The controller 20 then supplies power from the battery 8 to the electric motor 12 under control to rotate the motor shaft 50 at a controlled speed. The speed of the motor shaft 50 is controlled based on the rotational position of the speed adjustment switch 22 or on the state of a signal from the main switch 46 that changes based on the amount of operation on the trigger 48. The electric motor 12 is thus driven at a speed corresponding to the rotational position of the speed adjustment switch 22 or the amount of operation on the trigger 48. The rotational direction of the motor shaft 50 may be switchable.

The rotational force of the motor shaft 50 is converted to reciprocating motion with the power transmitter 28 and transmitted to the slider 30, the tip tool mount 32, and the blade 34.

As the motor shaft 50 rotates, the fan 14 rotates to produce an airflow (or specifically, wind) in the body 2. This cools the internal components of the jigsaw J including the electric motor 12.

The user presses the trigger 48 upward as appropriate to turn on the lock-on switch 42. In this case, the controller 20 maintains the rotation of the motor shaft 50 independently of the state of the main switch 46. Thus, with an operation on the lock-on switch 42, the user can continue to move the blade 34 vertically without pressing the trigger 48 upward continuously.

In response to the lock-on switch 42 being switched from an on-state to an off-state, the rotation of the motor shaft 50 is stopped.

The user places the workpiece acting part of the reciprocating blade 34 onto a target portion of the workpiece W, and moves the blade 34 relative to the workpiece W. The target portion of the workpiece W is then cut with the blade 34. As the blade 34 moves, the lower surface of the base unit 6 rubs against the upper surface of the workpiece W.

The user attaches the auxiliary base 1 appropriately based on the states of the body 2 and the handle 4. With the auxiliary base 1 being attached, the user can cut the workpiece W with the jigsaw J in a more stable manner. The auxiliary base 1 may be detached when, for example, the space is to be cleared around the base unit 6. The user can thus perform processing with the jigsaw J without the auxiliary base 1.

When the user starts cutting the workpiece W with the blade 34 being placed on one side of the workpiece W, the auxiliary base 1 located frontward from the blade 34 comes in contact with the workpiece W first before the blade 34 comes in contact with it. This allows sufficiently stable cutting with the jigsaw J.

The head 100 in the auxiliary base 1 has the first recess 111 and the second recess 112. Thus, when the first recess 111 or the second recess 112 faces downward and causes the first protrusion 115 or the second protrusion 116 to rub against the upper surface of the workpiece W as a contact portion, the head 100 receives a lower frictional force than when having no first recess 111 or no second recess 112. When the first recess 111 or the second recess 112 faces upward, the user can place a fingertip into the first recess 111 or the second recess 112. This improves the stability of the jigsaw J and increases processing workability of the jigsaw J.

The first recess 111 and the second recess 112 have different depths. The first protrusion 115 and the second protrusion 116 have different heights. Thus, the user can easily determine to place either the first recess 111 or the second recess 112 facing upward based on whether the cover plate C is attached. More specifically, when the cover plate C is not attached, the auxiliary base 1 is attached with the deeper first recess 111 facing upward. When the cover plate C is attached, the auxiliary base 1 is attached with the shallower second recess 112 facing upward.

When the processing is complete, the user stops sliding the trigger 48 upward to turn off the electric motor 12. The blade 34 then stops. The user turns off the main power switch 26 and detaches the battery 8, the blade 34, and the auxiliary base 1 as appropriate.

The first embodiment and its modifications are not limited to those described above, and may be modified as appropriate as, for example, described below.

The auxiliary base 1 may include components other than the head 100 and the leg 102.

The base unit 6 may include the base 60 alone, the base 60 and the cover plate C, or four or more components.

At least one of changing the orientation of the base unit 6 relative to the body 2, changing the position of the base unit 6 in the front-rear direction relative to the body 2, the orbital function, the lock-on function, ruler attachment, or the main power supply function separate from the trigger 48 may be eliminated or may be in other forms. The base unit 6 may include a mount dedicated to the auxiliary base 1.

The jigsaw J may include a power cord in place of the battery mount 18 to be AC powered with utility power. At least one of the cases or housings may be formed from a material such as resin, metal, or a composite material of these materials. The housing 10 may be divided differently from the manner described above. In addition, for example, at least one of the number, material, arrangement, structure, or type of any components or portions may be modified as appropriate.

The above embodiment or modifications may be applicable to a jigsaw that receives a tip tool other than the blade 34.

A second embodiment of the disclosure will now be described.

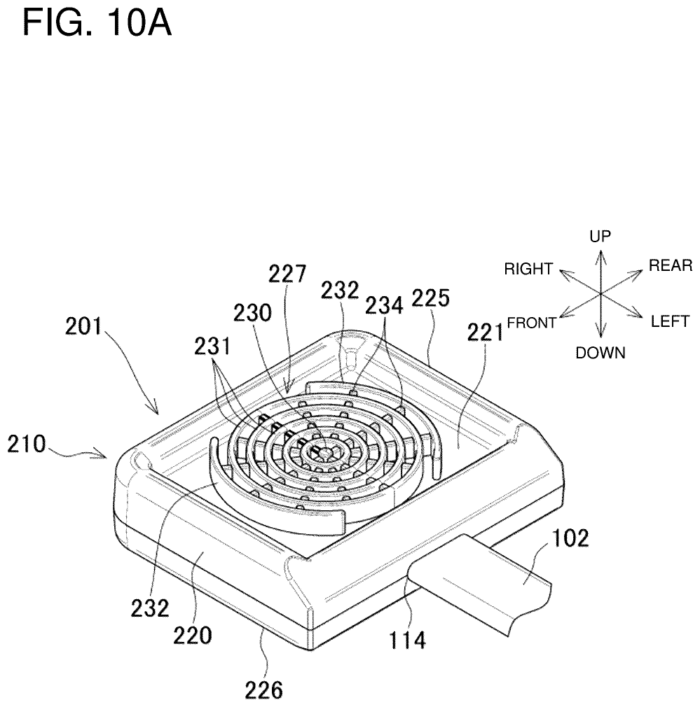

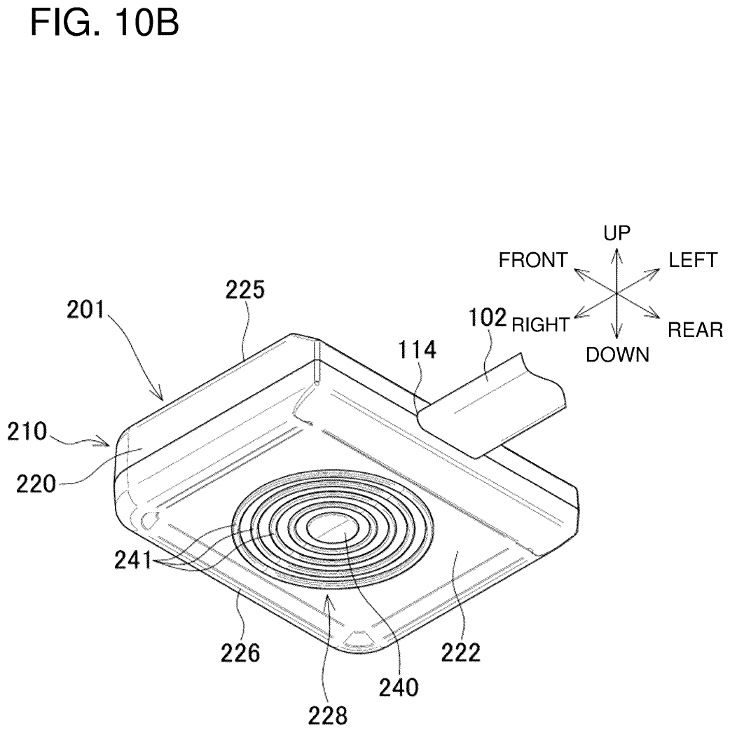

FIG. 10A is a perspective view of an auxiliary base 201 in a jigsaw according to the second embodiment. FIG. 10B is a perspective view of the auxiliary base 201 as viewed in the direction opposite to FIG. 10A.

The structure in the second embodiment is the same as in the first embodiment except the auxiliary base 201. In the second embodiment, like reference numerals denote like components and portions in the first embodiment. Such components will not be described.

The auxiliary base 201 is the same as the auxiliary base 1 according to the first embodiment except a head 210.

The head 210 is formed from plastic. The head 210 includes a head body 220, a first recess 221, a second recess 222, a slit 114, a first protrusion 225, a second protrusion 226, a first recess-protrusion portion 227, and a second recess-protrusion portion 228.

The head body 220 is a block or a plate. The head body 220 is larger than the head

body 110. The head body 220 may have the same size as or be smaller than the head body 110.

The first recess 221 is located on the upper surface of the head body 220. The first recess 221 is recessed downward from the upper surface of the head body 220. The first recess 221 defines the first protrusion 225 on an upper portion of the head body 220. The first protrusion 225 protrudes upward from the bottom surface of the first recess 221. The first protrusion 225 is rectangular and surrounds a center portion of the upper surface of the head body 220. Either the first recess 221 or the first protrusion 225 alone may be defined to relatively define the other of the first recess 221 or the first protrusion 225.

The second recess 222 is located on the lower surface of the head body 220. The second recess 222 is recessed upward from the lower surface of the head body 220. The second recess 222 defines the second protrusion 226 on a lower portion of the head body 220. The second protrusion 226 protrudes downward from the bottom surface of the second recess 222. The second protrusion 226 is rectangular and surrounds a center portion of the lower surface of the head body 220.

The second recess 222 is shallower than the first recess 221 in the vertical direction. The second protrusion 226 has a smaller height than the first protrusion 225 in the vertical direction. Either the second recess 222 or the second protrusion 226 alone may be defined to relatively define the other of the second recess 222 or the second protrusion 226. The second recess 222 may have a depth greater than or equal to the depth of the first recess 221. The second protrusion 226 may have a height greater than or equal to the height of the first protrusion 225. At least one of the first protrusion 225 or the second protrusion 226 may not be rectangular.

The slit 114 extends rightward from a center portion of the left surface of the head body 220.

At least one of the first recess 221, the second recess 222, the first protrusion 225, or the second protrusion 226 may be eliminated.

The first recess-protrusion portion 227 includes protrusions protruding upward from the bottom surface of the first recess 221 and recesses recessed downward between the protrusions. The first recess-protrusion portion 227 is surrounded by the first protrusion 225. The first recess-protrusion portion 227 includes a dot portion 230, multiple (four) circular portions 231, multiple (two) arc portions 232, and multiple (twelve) radial portions 234.

The dot portion 230 is cylindrical and protrudes upward. The dot portion 230 has a smaller height than the first protrusion 225.

The circular portions 231 protrude upward. Each circular portion 231 is centered on the dot portion 230 as viewed from above. The circular portions 231 are arranged concentrically as viewed from above. Each circular portion 231 has a smaller height than the first protrusion 225, and has a greater height than the dot portion 230.

The arc portions 232 protrude upward. Each arc portion 232 is arc-shaped and is centered on the dot portion 230 as viewed from above. The arc portions 232 are located on the right and left of the outer circular portion 231. Each arc portion 232 has a smaller height than the first protrusion 225, and has a greater height than the dot portion 230 and the circular portions 231. The dot portion 230, the circular portions 231, and the arc portions 232 have their upper ends along an imaginary spherical surface that is convex downward. In some embodiments, the upper ends of the circular portions 231 may be arranged along an imaginary spherical surface that is convex downward, and the upper ends of the other portions may be arranged at a lower level than the spherical surface.

The radial portions 234 protrude upward. The radial portions 234 extend radially from the dot portion 230 as viewed from above. The radial portions 234 extend from the dot portion 230 to the outer circular portion 231 and to the arc portions 232. Each radial portion 234 has a smaller height than the first protrusion 225.

At least one of the number, height, size, arrangement, or shape of any of the dot portion 230, the circular portions 231, the arc portions 232, and the radial portions 234 may be modified differently from those described above.

The second recess-protrusion portion 228 includes protrusions protruding downward from the bottom surface of the second recess 222 and recesses recessed upward between the protrusions. The second recess-protrusion portion 228 is surrounded by the second protrusion 226. The second recess-protrusion portion 228 includes a disk portion 240 and multiple (four) circular portions 241.

The disk portion 240 is disk-shaped and protrudes downward. The disk portion 240 has a smaller height than the second protrusion 226.

The circular portions 241 protrude downward. Each circular portion 241 is centered on the disk portion 240 as viewed from below. The circular portions 241 are arranged concentrically as viewed from the bottom to the top. Each circular portion 241 has a smaller height than the second protrusion 226, and has a greater height than the disk portion 240. The disk portion 240 and the circular portions 241 have their upper ends along an imaginary spherical surface that is convex upward.

The upper ends of the circular portions 241 may be arranged along an imaginary spherical surface that is convex upward, and the upper ends of the other portions may be arranged at a lower level than the spherical surface. At least one of the number, height, size, arrangement, or shape of any of the disk portion 240 and the circular portions 241 may be modified differently from those described above.

The head 210 in the auxiliary base 201 is larger than the head 100. When attached to the ruler mount 74, the head 210 has its rear end located more rearward than the blade 34 in the front-rear direction. The head 210 extends to a position more rearward than the blade 34. The first protrusion 225 and the second protrusion 226, which are contact portions of the head 210, extend to a position more rearward than the blade 34. The first protrusion 225 and the second protrusion 226 thus support the jigsaw J more stably than when the first protrusion 225 and the second protrusion 226 does not extend to a position more rearward than the blade 34.

The head 210 in the auxiliary base 201 has the first recess 221 and the second recess 222. Thus, when the first recess 221 or the second recess 222 faces downward and causes the first protrusion 225 or the second protrusion 226 to rub against the upper surface of the workpiece W as a contact portion, the head 210 receives a lower frictional force than when having no first recess 221 or no second recess 222. When the first recess 221 or the second recess 222 faces upward, the user can place a fingertip into the first recess-protrusion portion 227 or the second recess-protrusion portion 228. The first recess-protrusion portion 227 and the second recess-protrusion portion 228 have their protrusions and recesses to prevent slipping. This improves the stability of the jigsaw J and increases processing workability of the jigsaw J.

The first recess-protrusion portion 227 and the second recess-protrusion portion 228 have different shapes. The first protrusion 225 and the second protrusion 226 have different heights. Thus, the user can easily determine to place either the first recess 221 or the second recess 222 facing upward based on whether the cover plate C is attached. More specifically, when the cover plate C is not attached, the user may attach the auxiliary base 1 with the first recess-protrusion portion 227 facing upward to allow the deeper first recess 221 to face upward. In contrast, when the cover plate C is not attached, the user may attach the auxiliary base 1 with the second recess-protrusion portion 228 facing upward to allow the shallower second recess 222 face upward.

The second embodiment may be appropriately modified as in the first embodiment.

### Reference Signs List

1, 201 auxiliary base
2 body
6 base unit
8 battery
18 battery mount
34 blade
74 ruler mount
100, 210 head
102, 212 leg
115 first protrusion (contact portion)
116 second protrusion (contact portion)
227 first recess-protrusion portion
228 second recess-protrusion portion
G center of gravity
J jigsaw
W workpiece
WA auxiliary width
WB width

What is claimed is:

1. An auxiliary base attachable to a jigsaw, the jigsaw including a base unit to be in contact with a workpiece, and a body tiltable relative to the base unit in a lateral direction, the auxiliary base comprising:
a contact portion configured to be in contact with the workpiece when the auxiliary base is attached to the jigsaw,
wherein the auxiliary base is attachable with an auxiliary width from the contact portion to a middle of the base unit in the lateral direction of the body being greater than a width of the base unit in the lateral direction.

2. The auxiliary base according to claim 1, wherein
the contact portion is at a position farther in a direction in which the body is tilted than a center of gravity of the jigsaw having the body tilted at an angle of 45° in the lateral direction of the body.

3. An auxiliary base attachable to a jigsaw, the jigsaw including a base unit to be in contact with a workpiece, and a body tiltable relative to the base unit in a lateral direction, the auxiliary base comprising:
a contact portion configured to be in contact with the workpiece when the auxiliary base is attached to the jigsaw, the contact portion being at a position farther in a direction in which the body is tilted than a center of gravity of the jigsaw having the body tilted at an angle of 45° in the lateral direction of the body.

4. The auxiliary base according to claim 1, wherein
the jigsaw includes a battery and a battery mount.

5. The auxiliary base according to claim 1, wherein
the auxiliary base is at a position adjustable relative to the base unit in the lateral direction.

6. The auxiliary base according to claim 1, wherein
the auxiliary base is selectively attachable to and detachable from one of two ends of the base unit in the lateral direction.

7. The auxiliary base according to claim 1, wherein
the contact portion selectively supports one of two ends of the base unit in the lateral direction.

8. The auxiliary base according to claim 1, further comprising:
a head including the contact portion; and
a leg extending in the lateral direction and being attachable to the base unit,
wherein the head is connected to the leg with a first distance from an upper surface of the head to the leg in a vertical direction perpendicular to the horizontal direction being different from a second distance from a lower surface of the head to the leg in the vertical direction.

9. The auxiliary base according to claim 1, wherein
the base unit includes a ruler mount, and
the auxiliary base is attachable to the ruler mount.

10. The auxiliary base according to claim 1, wherein
the body includes a blade, and
the auxiliary base is located frontward from the blade in a front-rear direction perpendicular to the lateral direction.

11. The auxiliary base according to claim 1, wherein
the contact portion extends to a position more rearward than a blade in a front-rear direction.

12. The auxiliary base according to claim 1, further comprising:
a recess-protrusion portion.

13. The auxiliary base according to claim 12, further comprising:
a protrusion having a height greater than or equal to a height of the recess-protrusion portion and surrounding the recess-protrusion portion.

14. The auxiliary base according to claim 12, wherein
the auxiliary base includes a plurality of the protrusions with different shapes.

15. A jigsaw, comprising:
the auxiliary base according to claim 1.

16. The auxiliary base according to claim 2, wherein
the jigsaw includes a battery and a battery mount.

17. The auxiliary base according to claim 3, wherein
the jigsaw includes a battery and a battery mount.

18. The auxiliary base according to claim 2, wherein
the auxiliary base is at a position adjustable relative to the base unit in the lateral direction.

19. The auxiliary base according to claim 3, wherein
the auxiliary base is at a position adjustable relative to the base unit in the lateral direction.

20. The auxiliary base according to claim 4, wherein
the auxiliary base is at a position adjustable relative to the base unit in the lateral direction.
